(19) United States
(12) Patent Application Publication
(10) Pub. No.: US 2022/0072439 A1
(43) Pub. Date: Mar. 10, 2022

(54) FLOATING TOY PROJECTOR

(71) Applicant: Ankyo Developmet Ltd., Kowloon (CN)

(72) Inventor: Paul Lo, Kowloon (CN)

(73) Assignee: Ankyo Development Ltd.

(21) Appl. No.: 17/012,953

(22) Filed: Sep. 4, 2020

(51) Int. Cl. A63H 23/10; F21V 33/00; A63H 33/26

(52) U.S. Cl. CPC A63H 23/10; A63H 33/26; F21V 33/008

(57) ABSTRACT

A floating toy projector with a buoyant main body that includes an upper portion that sits above a water line in a pool of water and a lower portion that sits below the water line in the pool of water, a watertight inner space defined within the main body, a plurality of transparencies distributed across the lower portion of the main body, a light source assembly positioned within the inner space, a power supply positioned within in the inner space and electrically connected to the light source assembly, an activation switch positioned on the upper portion of the main body and electrically connected to the light source assembly, the activation switch providing for manual activation of the light source assembly and the light source assembly projecting light through the plurality of transparencies once the activation switch manually activates the light source assembly.

### FIELD

This application relates to a floating toy projector and, more specifically, to a floating toy protector shown as integrated within a floating toy plane.

### BACKGROUND

Toys for children are designed to be used both indoors and outdoors and in various types of environments. One specialized area of children's toys are toys designed for use in water and, more specifically, toys designed for use in a bathtub. Such toys are often used as an inducement to get children to take baths regularly and to occupy them so a supervising adult can adequately wash them. Such toys must have several common attributes, including being resilient and not easily breakable with parts that fragment and splinter as well as being sufficiently fun to engage a young child fully. The prior art discloses several toys for use by small children.

Nonetheless, there remains a need for a portable, lightweight toy that remains buoyant in a bathtub or other body of water for the enjoyment of children.

### SUMMARY

A floating toy projector is provided, the floating toy projector including a main body that is buoyant, the main body including an upper portion that sits above a water line in a pool of water, and a lower portion that sits below the water line in the pool of water. An inner space is defined within the main body that is watertight and a plurality of transparencies is distributed across the lower portion of the main body. A light source assembly is positioned within the inner space of the main body and a power supply is positioned within the inner space and is electrically connected to the light source assembly. An activation switch is positioned on the upper portion of the main body and is electrically connected to the light source assembly, the activation switch providing for manual activation of the light source assembly. The light source assembly projecting light through the plurality of transparencies once the activation switch manually activates the light source assembly.

### BRIEF DESCRIPTION OF THE DRAWINGS

The drawings, described below, are for illustrative purposes only and are not necessarily drawn to scale. The drawings are not intended to limit the scope of the disclosure in any way. Wherever possible, the same or like reference numbers are used throughout the drawings to refer to the same or like parts.

FIG. 1 is an upper perspective view of a floating toy projector according to the embodiments disclosed herein;

FIG. 2 is a lower perspective view of a floating toy projector according to the embodiments disclosed herein;

FIG. 3 is an exploded view of a floating toy projector according to the embodiments disclosed herein; and

FIG. 4 is a perspective view of a floating toy projector floating in a pool of water according to the embodiments disclosed herein.

FIG. 5 is a schematic view of a light source assembly according to the embodiments disclosed herein.

### DETAILED DESCRIPTION

As mentioned above, this application relates to a floating toy projector, and more specifically, to a floating toy protector integrated within a floating toy plane.

The floating toy projector disclosed herein includes a buoyant main body that may be integrated within any of multiple toy like embodiments. In the present disclosure, the main body of the floating toy projector is shown integrated within a toy plane. The integration of the main body into the toy plane embodiment disclosed herein providing for a toy plane with the structural elements and functionality of a floating toy projector, as claimed herein. The floating toy projector providing for the projection of light through a plurality of transparencies positioned on a portion of the main body that is submerged below a water line in a pool of water.

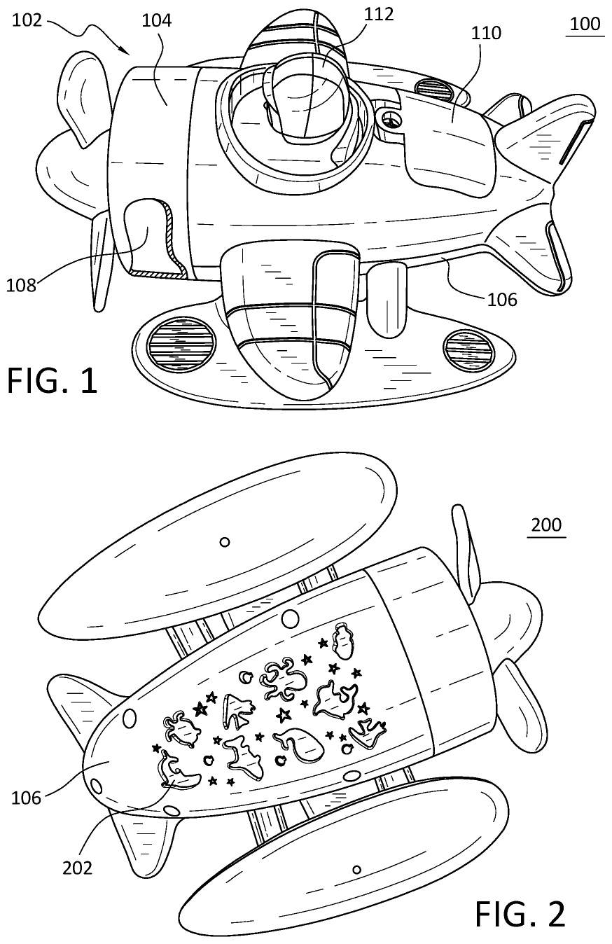

FIG. 1 is an upper perspective view of a floating toy projector 100 according to the embodiments disclosed herein. In the embodiment shown in FIG. 1, the floating toy projector 100 is embodied within a floating toy plane. Specifically, in the embodiment shown in FIG. 1, the main body 102 is shaped as a fuselage that is integrated within the floating toy plane 100. In other embodiments, the main body 102 may take on different shapes that conform to structural components of other floating toys while remaining within the scope of the present disclosure. As an example, the main body 102 may be shaped as the cylindrical main body of a toy submarine while remaining within the scope of the present disclosure. As such, other toy-like embodiments that integrate the main body 102 as disclosed, in one form or another, still fall within the scope of the disclosed embodiments.

The main body 102 may include an upper portion 104 and a lower portion 106. The upper portion 104 and the lower portion 106 are joined together as opposing sides of the main body 102. The joined upper portion 104 and lower portion 106 define an inner space 108 fully encompassed within the main body 102. The upper portion 104 and the lower portion 106 are joined in a manner such that the inner space 108 is watertight. As such, the main body 102 remains buoyant when placed in a pool of water. The upper portion 104 may include a battery compartment 110 and an activation switch 112.

FIG. 2 is a lower perspective view of a floating toy projector 200 according to the embodiments disclosed herein. The lower portion 106 may include a plurality of transparencies 202. Each of the plurality of the transparencies 202 may have a different distinct shape, or they may all have a similar shape. The plurality of transparencies 202 may be distributed as a specific pattern or randomly across the lower portion 106. The plurality of transparencies 202 is designed to allow light generated from within the inner space 108 to project outward through each of the plurality of transparencies 202 as a distinct shape.

In one embodiment, each of the plurality of transparencies 202 is shaped like fish, whales, turtles, or any other animals commonly found in the ocean.

The main body 102 may be composed of and formed from any waterproof material known to one of ordinary skill in the art, including plastic and metal.

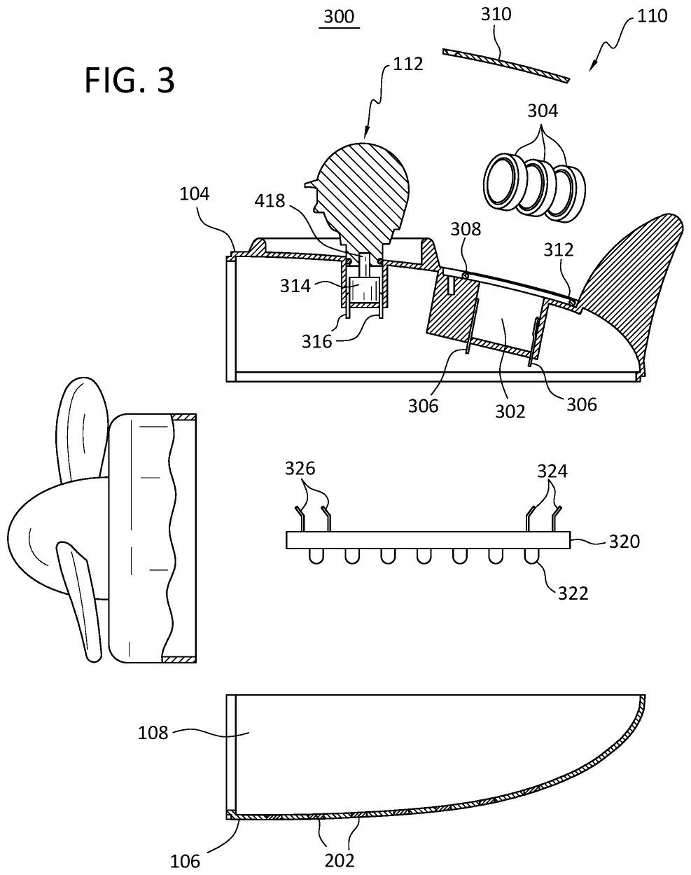

FIG. 3 is an exploded view of a floating toy projector 300 according to the embodiments disclosed herein. The battery compartment 110 included on the upper portion 104 may include a depression 302 formed within the upper portion 104 that is sized and shaped to hold a plurality of batteries 304. The depression 302 may include a pair of battery connectors 306 extending from within the depression 302 and into the inner space 108. The battery connectors 306 are in electrical communication with the plurality of batteries 304 when they are positioned within the depression 302. Accordingly, the pair of battery connectors 306 provides electrical access to the plurality of batteries 304 when placed within the depression 302.

The battery compartment 110 may further include an O-ring 308 and a lid 310. The O-ring 308 is designed to sit along a perimeter 312 of the depression 302 and is composed of waterproof material. The lid 310 is designed to sit over the O-ring 308 and is removably secured to the upper portion 104. The lid 310 and the O-ring 308 together cooperate to make a watertight seal that enables the depression 302 to remain waterproof while main body 102 is floating in a pool of water.

The activation switch 112 may be a mechanical push button switch 314 with a pair of switch connectors 316 positioned within the inner space 108. The activation switch 112 providing a temporary electrical closure between the pair of switch connectors 316 while the push button switch 314 is manually activated.

The activation switch 112 may further include a watertight plunger 318 coupled to the upper portion 104, the watertight plunger 318 allowing for manual activation of the mechanical push button switch 314.

The inner space 108 may include a light source assembly 320 that includes a plurality of light sources 322. Each of the plurality of light sources 322 may be positioned within the inner space 108 so as to project light towards the plurality of transparencies 202.

In one embodiment, each of the plurality of light sources 322 is a light-emitting diode (LED), all of the light-emitting diodes emitting the same color of light or each emitting a different color of light.

The light source assembly 320 may further include a first set of electrical connections 324 that electrically connect the light source assembly 320 to the battery compartment 110. The first set of electrical connections 324 providing electrical power to the light source assembly 320 from the plurality of batteries 304 positioned within the depression 302 of the battery compartment 110.

The light source assembly 320 may further include a second set of electrical connections 326 that electrically connect the light source assembly 320 to the activation switch 112. The second set of electrical connections 326 providing a temporary electrical closure between the second set of electrical connections 326 while the mechanical push button switch 314 is manually activated.

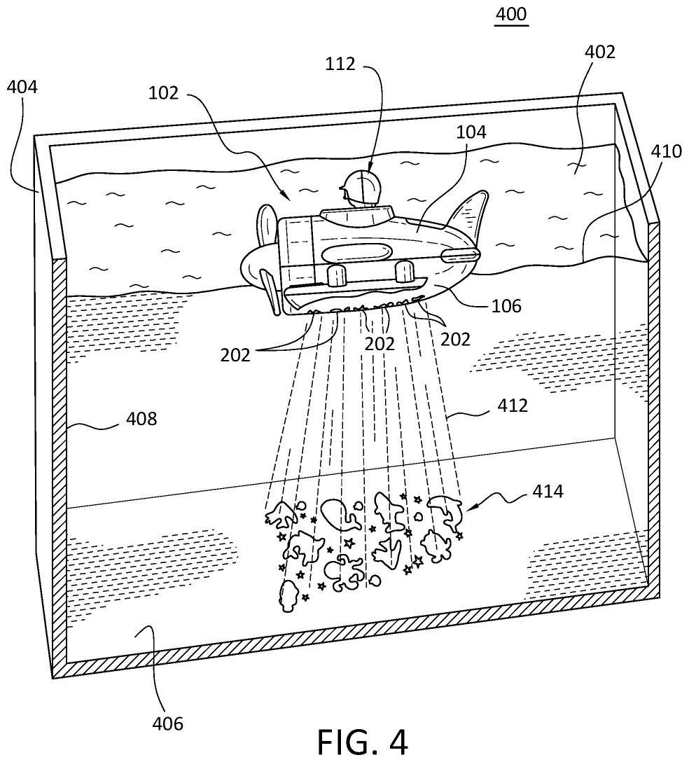

FIG. 4 is a perspective view of a floating toy projector 400 floating on a pool of water 402 according to the embodiments disclosed herein. The pool of water 402 may be contained within a container 404, the container 404 including a floor 406 and side walls 408 which define the space containing the pool of water 402.

The floating toy projector 400 floats in the pool of water 402 such that a majority of the lower portion 106 of the main body 102 is submerged below a water line 410. It follows that a majority of the upper portion 104 of the main body 102 sits above the waterline 410.

As shown, each of the plurality of transparencies 202 is fully submerged below the water line 410 of the pool of water 402 and each of the plurality lights 322 is facing down towards the floor 406 of the container 404. A such, light generated within the inner space 108 by the light source assembly 320 is projected outward through each of the plurality of transparencies 202. The projected light 412 emitting from the plurality of transparencies 202 is projected downward towards the floor 406 of the container 404. Once the projected light 412 hits the floor 406 of the container 404, a series of images shaped like each of the plurality of transparencies 202 is then formed on the floor 406.

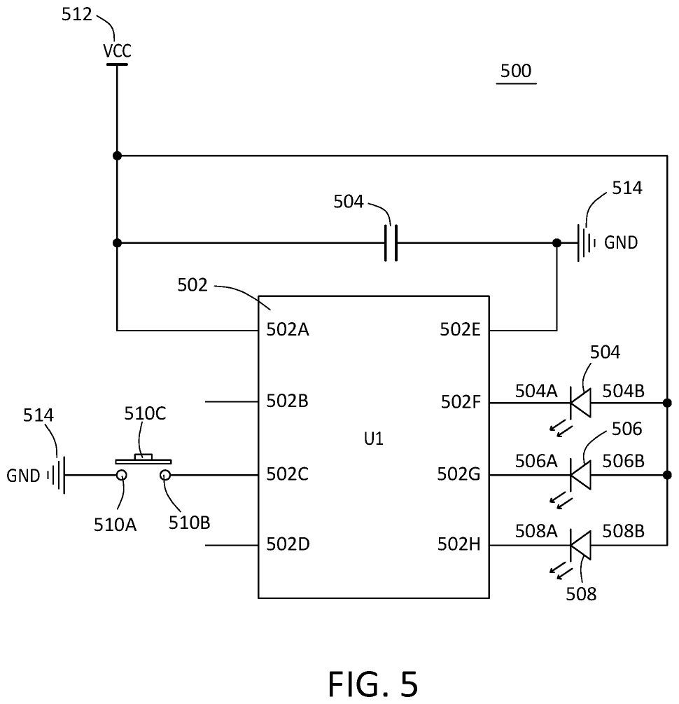

FIG. 5 is a schematic view of a light source assembly 500 according to the embodiments disclosed herein. The light source assembly 500 may include a controlled 502, a first LED 504, a second LED 506, a third LED 508, a switch 510, a power supply 512, and a ground 514.

The first LED 504, the second LED 506, and the third LED 508 are representative of the plurality of light sources 322 discusses above. The power supply 512 is representative of the battery compartment 110 discussed above. Lastly, the switch 510 is representative of the activation switch 112 discussed above.

The controller 502 may be an integrated circuit with a plurality of individual electrical inputs 502A-502H.

Each of the first LED 504, the second LED 506, and third LED 508 may include a first cathode 504A, a second cathode 506A, and a third cathode 508A, respectively, as well as a first anode 504B, a second anode 506B, and a third anode 508B, respectively.

The first anode 504B, the second anode 506B, and the third anode 508B are each electrically connected to the power supply 512. The first cathode 504A is electrically connected to the input 502F of the controller 502. The second cathode 506A is electrically connected to the input 502G of the controller 502. The third cathode 508A is electrically connected to the input 502H of the controller 502.

The switch 510 may include a first pole 510A, a second pole 510B, and a push-button throw 510C. The first pole 510A is electrically connected to the ground 514. The second pole 510B is electrically connected to the input 502C of the controller 502.

The power supply 512 is further electrically connected to the input 502A of the controller 502. The ground 514 is further electrically connected to the input 502E of the controller 502.

The controller 502 controls the flow of current to each of the first LED 504, the second LED 506, and the third LED 508 in response to the manual actuation of the switch 510. The flow of current thought each of the first LED 504, the second LED 506, and the third LED 508 may occur simultaneously or may occur in any predefined sequence. While the embodiment shown in FIG. 5 includes only three LEDs, a person of ordinary skill in the art will understand that any number of LEDs may be electrically connected to any number of inputs on the controller 502.

The foregoing description discloses only example embodiments. Modifications of the above-disclosed assemblies and methods which fall within the scope of this disclosure will be readily apparent to those of ordinary skill in the art.

This disclosure is not intended to limit the invention to the particular assemblies and/or methods disclosed, but, to the contrary, the intention is to cover all modifications, equivalents, and alternatives falling within the scope of the claims.

What is claimed is:

1. A floating toy projector, comprising:
a main body that is buoyant, the main body including an upper portion that sits above a water line in a pool of water and a lower portion that sits below the water line in the pool of water;
an inner space defined within the main body that is watertight;
a plurality of transparencies distributed across the lower portion of the main body;
a light source assembly positioned within the inner space of the main body;
a power supply positioned within in the inner space and electrically connected to the light source assembly;
an activation switch positioned on the upper portion of the main body and electrically connected to the light source assembly, the activation switch providing for manual activation of the light source assembly; and
the light source assembly projecting light through the plurality of transparencies once the activation switch has been manually activated.

2. The floating toy projector of claim 1, wherein the light source assembly includes a plurality of light-emitting diodes.

3. The floating toy projector of claim 2, wherein each of the plurality of light-emitting diodes emits a different color of light once the activation switch has been manually activated; and
wherein the light source assembly sequences between each of the plurality of light-emitting diodes once the activation switch has been manually activated.
